(19) United States
(12) Patent Application Publication
(10) Pub. No.: US 2011/0072864 A1
(43) Pub. Date: Mar. 31, 2011

(54) Key cylinder punch-in protector

(76) Inventor: David M. Schardt, Milwaukee, WI (US)

(21) Appl. No.: 12/566,931

(22) Filed: Sep. 25, 2009

(51) Int. Cl. E05B 65/00

(52) U.S. Cl. 70/91

(57) ABSTRACT

An assembly that includes solid blocking placed between the interior door panel and the key cylinder of a vehicle that restricts the cylinder from being turned without the appropriate key when the cylinder is pushed into the cavity of the door.

### CROSS-REFERENCE TO RELATED APPLICATIONS

Not Applicable

### BACKGROUND/TECHNICAL FIELD OF THE INVENTION

This invention relates generally to automobile security devices.

Current technology/manufacturing of doors has an exterior and interior panel of the door with a cavity between them. Traditionally the locking mechanism is attached to the exterior panel. On some model the area between the backside of the locking mechanism and the interior panel allows the key cylinder to be pushed inwards allowing the entire mechanism to turn freely inside the cavity of the door. In many vehicles the amount of force required to break the mechanism designed to hold the cylinder to the exterior panel is so small that the average person can hit the exterior of the cylinder with a blow from their hand and break the cylinder free.

### BRIEF SUMMARY OF THE INVENTION

This design consists of solid blocking placed between the interior panel of the door and the backside of the key cylinder. The blocking is placed so as to remove the void behind the cylinder. Any force applied to the exterior of the key cylinder is distributed to the rigid interior panel preventing the key cylinder to be pushed out of the key cylinder housing. The blocking is secured to the interior panel of the door with a screw. If the factory mechanism designed to hold the key cylinder in place fails, the blocking is sized and positioned to keep the cylinder from moving out of its housing but still allowing rotational movement for normal operation.

### BRIEF DESCRIPTION OF VIEWS OF THE DRAWING

FIG. 1 is a side cross sectional view of the preferred embodiment of the present invention.

### DETAILED DESCRIPTION OF THE INVENTION

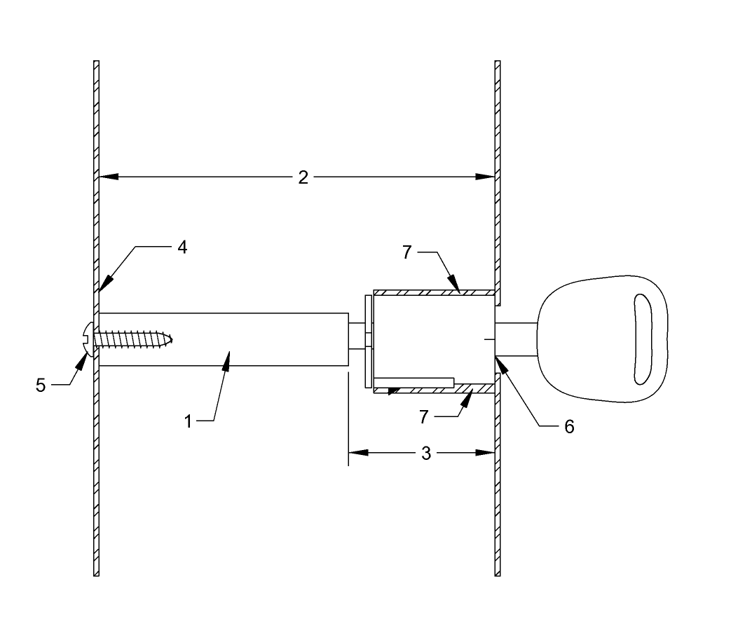

The key cylinder punch-in protector of the present invention, in any of its alternative embodiments, illustrated in FIGS. 1, is solid blocking 1 that is sized and shaped to fill the cavity 2 of the door panel of a vehicle behind the key cylinder 3. The solid blocking 1 is attached to the interior panel 4 of the vehicle with a screw 5 so as to distribute pressure from the exterior of the key cylinder 6 to the interior door panel 4 and thus maintaining the key cylinder's position within the key cylinder's housing 7.

The illustrations and description of the key cylinder punch-in protector of the present invention are to be considered as illustrative and not restrictive in character, it being understood that only the preferred embodiment has been shown and described and that all changes and modifications that come within the spirit of the invention are desired to be protected.

1. Key cylinder punch-in protector, consisting of:
a rigid solid block that fills the void between an interior door panel and key cylinder so that when pressure is applied to the exterior of the cylinder, the force is distributed to thee interior panel to which the block is attached.
